(19) United States
(12) Patent Application Publication
(10) Pub. No.: US 2026/0180194 A1
(43) Pub. Date: Jun. 25, 2026

(54) ANTENNA STRUCTURE

(71) Applicant: WNC Corporation, Hsinchu (TW)

(72) Inventors: Tzu-Min WU, Hsinchu (TW); Yi-Teng HSIAO, Hsinchu (TW); Kuo-Jen LAI, Hsinchu (TW); Kuang-Yuan KU, Hsinchu (TW)

(21) Appl. No.: 19/387,999

(22) Filed: Nov. 13, 2025

(30) Foreign Application Priority Data
Dec. 24, 2024 (TW) 113150361

(51) Int. Cl. H01Q 13/20; H01Q 1/50

(52) U.S. Cl. CPC H01Q 13/20; H01Q 1/50

(57) ABSTRACT

An antenna structure includes a first ground plane, a first capacitor, a feeding element, a dielectric substrate, and a metal cavity. The first ground plane includes a narrow edge segment and a wide edge segment. The first ground plane has a first slot. The first capacitor is coupled between the narrow edge segment and the wide edge segment. The first slot of the first ground plane is excited by the feeding element. The dielectric substrate has a first surface and a second surface which are opposite to each other. The first ground plane, the first capacitor, and the feeding element are disposed on the first surface of the dielectric substrate. The metal cavity is coupled to the first ground plane. The metal cavity is adjacent to the dielectric substrate.

### CROSS-REFERENCE TO RELATED PATENT APPLICATION

This application claims the benefit of priority to Taiwan Patent Application No. 113150361, filed on Dec. 24, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### BACKGROUND OF THE DISCLOSURE

### Field of the Disclosure

The present disclosure relates to an antenna structure, particularly to a wideband antenna structure.

### Description of the Related Art

With the development of mobile communication technology, mobile devices have become increasingly common in recent years. Common examples include laptops, mobile phones, multimedia players, and other portable electronic devices with mixed functions. To meet people's needs, mobile devices usually have wireless communication functions. Some cover long-distance wireless communication ranges, such as mobile phones using 2G, 3G, LTE (Long Term Evolution) systems and communicate using frequency bands of 700 MHz, 850 MHz, 900 MHz, 1800 MHz, 1900 MHz, 2100 MHz, 2300 MHz, and 2500 MHz, while others cover short-distance wireless communication ranges, such as Wi-Fi and Bluetooth systems using frequency bands of 2.4GHz, 5.2GHz, and 5.8GHz.

Antennas are indispensable components in the field of wireless communication. If the operational bandwidth of an antenna used for receiving or transmitting signals is too narrow, it can easily lead to a decline in the communication quality of mobile devices. Therefore, how to design a small-sized, wideband antenna structure is an important issue for designers.

### SUMMARY OF THE DISCLOSURE

In an embodiment, the present disclosure proposes an antenna structure that includes a first ground plane, a first capacitor, a feeding element and a metal cavity. The first ground plane includes a narrow edge segment and a wide edge segment, wherein the first ground plane has a first slot. The first capacitor is coupled between the narrow edge segment and the wide edge segment. The first slot of the first ground plane is excited by the feeding element. The dielectric substrate has a first surface and a second surface opposite to each other. The first ground plane, the first capacitor, and the feeding element are disposed on the first surface of the dielectric substrate. The metal cavity is coupled to the first ground plane and is adjacent to the dielectric substrate.

In some embodiments, the antenna structure further includes a second capacitor, wherein the feeding element is coupled to a feeding point on the wide edge segment via the second capacitor.

In some embodiments, the capacitance of each of the first capacitor and the second capacitor is less than or equal to 2 pF.

In some embodiments, the antenna structure covers a first frequency band and a second frequency band, the first frequency band is lower than the second frequency band.

In some embodiments, using the feeding point as a reference point, the first slot of the first ground plane can be divided into a longer portion and a shorter portion. The length of the longer portion is from 0.25 to 0.5 wavelength of the first frequency band, and the length of the shorter portion is from 0.125 to 0.5 wavelength of the second frequency band.

In some embodiments, the antenna structure further includes an independent metal element, disposed inside the first slot of the first ground plane, wherein the feeding element is coupled to a feeding point on the independent metal element, and the independent metal element is adjacent to the narrow edge segment and the wide edge segment.

In another embodiment, the present disclosure proposes an antenna structure that includes a first ground plane, a feeding element, a substrate, and a metal cavity. The first ground plane includes a narrow edge segment and a wide edge segment, wherein the first ground plane has a first slot. The first slot of the first ground plane is excited by the feeding element. The dielectric substrate has a first surface and a second surface that are opposite to each other, wherein the first ground plane and the feeding element are both disposed on the first surface of the dielectric substrate. The metal cavity is coupled to the first ground plane and is adjacent to the dielectric substrate. The narrow edge segment further includes a plurality of first protruding portions, and the wide edge segment further includes a plurality of second protruding portions, the first protruding portions and the second protruding portions are arranged in an interleaved manner to form a capacitive region.

In some embodiments, the metal cavity is an uncovered hollow rectangular cuboid.

In some embodiments, the first surface of the dielectric substrate faces an open side of the metal cavity.

In some embodiments, a first coupling gap is formed between the first protruding portions of the narrow edge segment and the second protruding portions of the wide edge segment, and the width of the first coupling gap is less than or equal to 1 mm.

In some embodiments, the length of the capacitive region is less than the length of the other portions of the first slot of the first ground plane.

In some embodiments, the antenna structure further includes a capacitor, wherein the feeding element is coupled to a feeding point on the wide edge segment via the capacitor.

In some embodiments, the capacitance of the capacitor is less than or equal to 2 pF.

In some embodiments, the antenna structure further includes a second ground plane, disposed on the second surface of the dielectric substrate. The second ground plane has a second slot. A plurality of conductive via elements penetrate the dielectric substrate, coupling the second ground plane to the first ground plane.

In some embodiments, the second slot of the second ground plane is substantially aligned with the first slot of the first ground plane.

In some embodiments, a second coupling gap is formed between the independent metal element and the narrow edge segment, and a third coupling gap is formed between the independent metal element and the wide edge segment, and the width of each of the second coupling gap and the third coupling gap is less than or equal to 2 mm.

In some embodiments, the independent metal element has a vertical projection on the second surface of the dielectric substrate, and the vertical projection at least partially overlaps the second slot of the second ground plane.

In some embodiments, the antenna structure further includes an additional metal element disposed inside the first slot of the first ground plane, which is coupled to the narrow edge segment or the wide edge segment.

In another embodiment, the present disclosure proposes an antenna structure that includes a metal cavity and a cable. The metal cavity includes a metal member having a slot. The metal member includes a narrow edge segment and a wide edge segment. The cable includes a feeding element and a grounding element. The feeding element is coupled to the wide edge segment, and the grounding element is coupled to the narrow edge segment. The narrow edge segment further includes a plurality of first protruding portions, and the wide edge segment further includes a plurality of second protruding portions, the first protruding portions and the second protruding portions are arranged in an interleaved manner to form a capacitive region

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The disclosure can be more fully understood by reading the subsequent detailed description and examples with references made to the accompanying drawings, wherein:

FIG. 1A is an exploded view showing the antenna structure according to an embodiment of the present disclosure.

FIG. 1B is a partial view showing the antenna structure according to an embodiment of the present disclosure.

FIG. 2A is a partial view showing the antenna structure according to an embodiment of the present disclosure.

FIG. 2B is another partial view showing the antenna structure according to an embodiment of the present disclosure.

FIG. 2C is a partial view showing the antenna structure according to an embodiment of the present disclosure.

FIG. 2D is a partial view showing the antenna structure according to an embodiment of the present disclosure.

FIG. 3A is an exploded view showing the antenna structure according to an embodiment of the present disclosure.

FIG. 3B is a partial view showing the antenna structure according to an embodiment of the present disclosure.

FIG. 4A is a partial view showing the antenna structure according to an embodiment of the present disclosure.

FIG. 4B is another partial view showing the antenna structure according to an embodiment of the present disclosure.

FIG. 4C is a partial view showing the antenna structure according to an embodiment of the present disclosure.

FIG. 5A is a partial view showing the antenna structure according to an embodiment of the present disclosure.

FIG. 5B is another partial view showing the antenna structure according to an embodiment of the present disclosure.

FIG. 5C is a partial view showing the antenna structure according to an embodiment of the present disclosure.

FIG. 6A is a partial view showing the antenna structure according to an embodiment of the present disclosure.

FIG. 6B is a partial view showing the antenna structure according to an embodiment of the present disclosure.

FIG. 7 is a perspective view showing the antenna structure according to an embodiment of the present disclosure.

### DETAILED DESCRIPTION OF THE EXEMPLARY EMBODIMENTS

In order to illustrate the purposes, features, and advantages of the present disclosure more apparent and understandable, specific embodiments of the present disclosure are exemplified below, along with detailed descriptions in conjunction with the accompanying drawings.

Certain terms are used throughout the description and following claims to refer to particular components. It should be understood by those skilled in the art that hardware manufacturers may use different terms to refer to the same component. This document does not intend to distinguish components by name differences but by the functional differences of the components. The terms “comprising” and “including” as used throughout the specification and claims are open-ended terms, and thus should be interpreted as “including but not limited to.” The term “substantially” refers to within an acceptable error range, where those skilled in the art can solve the described technical problem and achieve the described basic technical effect within a certain error range. Furthermore, the term “coupled” as used in this specification includes any direct and indirect electrical connection means. Therefore, if it is described that a first device is coupled to a second device, it means that the first device can be electrically connected directly to the second device or indirectly electrically connected to the second device via other devices or connection means.

The following disclosure provides many different embodiments or examples to implement different features of this case. The following disclosure describes specific examples of various components and their arrangements to simplify the description. Of course, these specific examples are not intended to be limiting. For example, if the disclosure describes a first feature formed on or above a second feature, it means that it may include embodiments where the first feature and the second feature are in direct contact, and it may also include embodiments where additional features are formed between the first feature and the second feature, such that the first feature and the second feature may not be in direct contact. Additionally, different examples in the following disclosure may repeatedly use the same reference numerals and/or labels. These repetitions are for simplification and clarity purposes and are not intended to imply a specific relationship between the different embodiments and/or structures discussed.

Furthermore, spatially relative terms, such as “beneath,” “below,” “lower,” “above,” “upper,” and similar terms, are used to describe the relationship of one element or feature to another element(s) or feature(s) as illustrated in the figures. In addition to the orientations depicted in the drawings, these spatially relative terms are intended to encompass different orientations of the device in use or operation. The device may be oriented differently (rotated 90 degrees or other orientations), and the spatially relative terms used herein can be similarly interpreted accordingly.

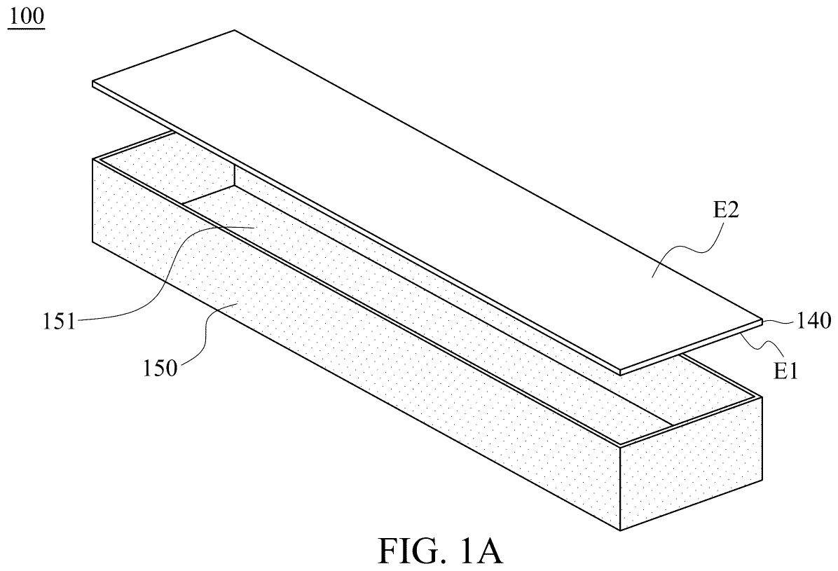

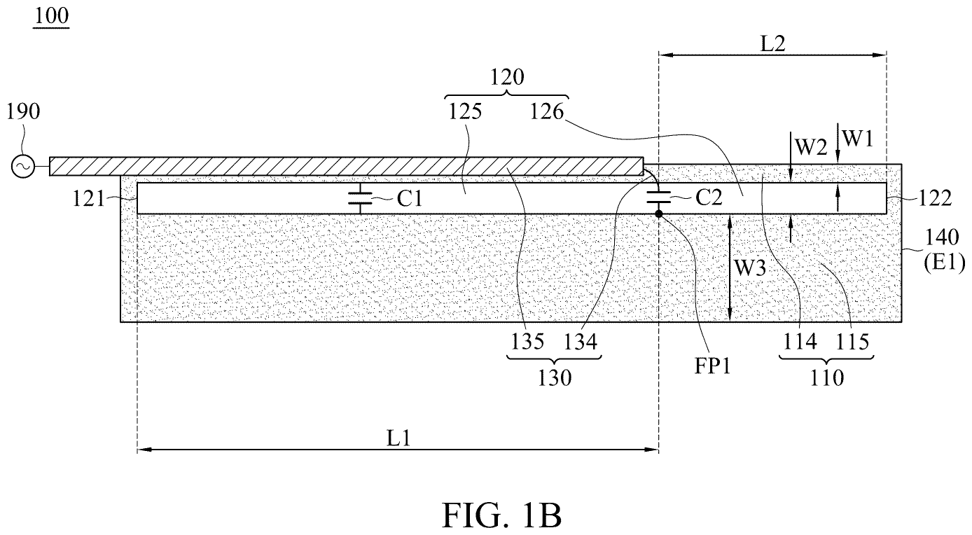

FIG. 1A is an exploded view showing the antenna structure 100 according to an embodiment of the present disclosure. FIG. 1B is a partial view showing the antenna structure 100 according to an embodiment of the present disclosure. Please refer to both FIG. 1A and FIG. 1B. The antenna structure 100 can be applied in a mobile device, such as a smartphone, a tablet computer, or a notebook computer. In the embodiment shown in FIGS. 1A and 1B, the antenna structure 100 includes a first ground plane 110, a first capacitor C1, a cable 130, a dielectric substrate 140, and a metal cavity 150, wherein the first ground plane 110 can be made of a metallic material, such as copper, silver, aluminum, iron, or their alloys.

The first ground plane 110 includes a narrow edge segment 114 and a wide edge segment 115 that are coupled to each other. Additionally, the first ground plane 110 has a first slot 120, which can be located between the narrow edge segment 114 and the wide edge segment 115. For example, the first slot 120 of the first ground plane 110 can be a substantially straight closed slot, which can have a first closed end 121 and a second closed end 122 that are mutually distant. In some embodiments, the first ground plane 110 may be substantially a large rectangle, but is not limited thereto.

The first capacitor C1 is coupled between the narrow edge segment 114 and the wide edge segment 115. For example, the first capacitor C1 can span across the first slot 120 of the first ground plane 110. That is, the first capacitor C1 has a first end and a second end, wherein the first end of the first capacitor C1 is coupled to the narrow edge segment 114, and the second end of the first capacitor C1 is coupled to the wide edge segment 115. In some embodiments, the first capacitor C1 can be implemented by a lumped capacitor. However, the present disclosure is not limited thereto. In other embodiments, the first capacitor C1 can also be implemented by a distributed capacitor.

The cable 130 includes a feeding element 134 and a grounding element 135, wherein the first slot 120 of the first ground plane 110 can be excited by the feeding element 134, and the grounding element 135 is coupled to the narrow edge segment 114. For example, the cable 130 can be a coaxial cable, wherein the feeding element 134 can be a central conductor of the coaxial cable, and the grounding element 135 can be a conductive housing of the coaxial cable, but is not limited thereto. In some embodiments, the feeding element 134 is coupled to a positive electrode of a signal source 190, and the grounding element 135 is coupled to a negative electrode of the signal source 190. For example, the signal source 190 can be a radio frequency (RF) module. In other embodiments, the antenna structure 100 can also include only the feeding element 134, without the cable 130, wherein the feeding element 134 can be implemented by a pogo pin.

In some embodiments, the antenna structure 100 further includes a second capacitor C2, wherein the feeding element 134 can be coupled to a feeding point FP1 on the wide edge segment 115 via the second capacitor C2. For example, the second capacitor C2 can be implemented by another lumped capacitor or another distributed capacitor, but is not limited thereto. Additionally, using the feeding point FP1 as a reference point, the first slot 120 of the first ground plane 110 can be divided into a longer portion 125 and a shorter portion 126, wherein the first capacitor C1 can be substantially located at the center of the longer portion 125 of the first slot 120 of the first ground plane 110. It should be understood that in other embodiments, the second capacitor C2 is an optional element and can be removed in other embodiments.

For example, the dielectric substrate 140 can be an FR4 (Flame Retardant 4) substrate, a printed circuit board (PCB), or a flexible printed circuit (FPC). The dielectric substrate 140 has a first surface E1 and a second surface E2 opposite to each other, wherein the first ground plane 110, the first capacitor C1, and the cable 130 can be disposed on the first surface E1 of the dielectric substrate 140, while no metal components may be arranged on the second surface E2 of the dielectric substrate 140. However, the present disclosure is not limited thereto. In other embodiments, the first ground plane 110, the first capacitor C1, and the cable 130 can also be disposed on the second surface E2 of the dielectric substrate 140.

The metal cavity 150 is coupled to the first ground plane 110. For example, the metal cavity 150 can be a substantially uncovered hollow rectangular cuboid, but is not limited thereto. The metal cavity 150 is adjacent to the dielectric substrate 140. In some embodiments, the first surface E1 of the dielectric substrate 140 faces an open side 151 of the metal cavity 150, allowing the cable 130 to be hidden inside the metal cavity 150. It should be noted that the term “close to” or “adjacent to” in this specification can refer to a situation where the distance between the corresponding two elements is less than a critical distance (e.g., 10 mm or shorter) and can also include a situation where the corresponding two elements are in direct contact with each other (i.e., the aforementioned distance is reduced to 0).

In some embodiments, the antenna structure 100 can cover a first frequency band and a second frequency band. For example, the first frequency band can be from 2400 MHz to 2500 MHz, and the second frequency band can be from 5150 MHz to 7125 MHz. Therefore, the antenna structure 100 can at least support broadband operation of WLAN (Wireless Local Area Network), Wi-Fi 6E, and Wi-Fi 7.

In some embodiments, the operating principle of the antenna structure 100 can be described as follows. The longer portion 125 of the first slot 120 of the first ground plane 110 can be excited to generate the first frequency band. The shorter portion 126 of the first slot 120 of the first ground plane 110 can be excited to generate the second frequency band. According to actual measurement results, the first capacitor C1 can be used to adjust the frequency shift of the first frequency band of the antenna structure 100, while the second capacitor C2 can be used to increase the bandwidth of the first frequency band of the antenna structure 100. Additionally, the inclusion of the metal cavity 150 can prevent the radiation performance of the antenna structure 100 from being negatively affected by environmental noise.

In some embodiments, the component sizes and parameters of the antenna structure 100 can be described as follows. The length L1 of the longer portion 125 of the first slot 120 of the first ground plane 110 can be from 0.25 to 0.5 wavelength of the first frequency band of the antenna structure 100 (λ/4˜λ/2). The length L2 of the shorter portion 126 of the first slot 120 of the first ground plane 110 can be from 0.125 to 0.5 wavelength of the second frequency band of the antenna structure 100 (λ/8˜λ/2). The width W1 of the narrow edge segment 114 can be less than or equal to 2 mm. The width W2 of the first slot 120 of the first ground plane 110 can be less than or equal to 2 mm. The width W3 of the wide edge segment 115 can be at least three times greater than the width W1 of the narrow edge segment 114. The capacitance of the first capacitor C1 can be less than or equal to 2 pF. The capacitance of the second capacitor C2 can also be less than or equal to 2 pF. The above component sizes and parameter ranges are derived from multiple experimental results, which help to optimize the operational bandwidth and impedance matching of the antenna structure 100, while also suppressing noise interference in the antenna structure 100.

The following embodiments will introduce different configurations and detailed structural features of the antenna structure 100. It must be understood that these figures and descriptions are merely examples and are not intended to limit the scope of the present disclosure.

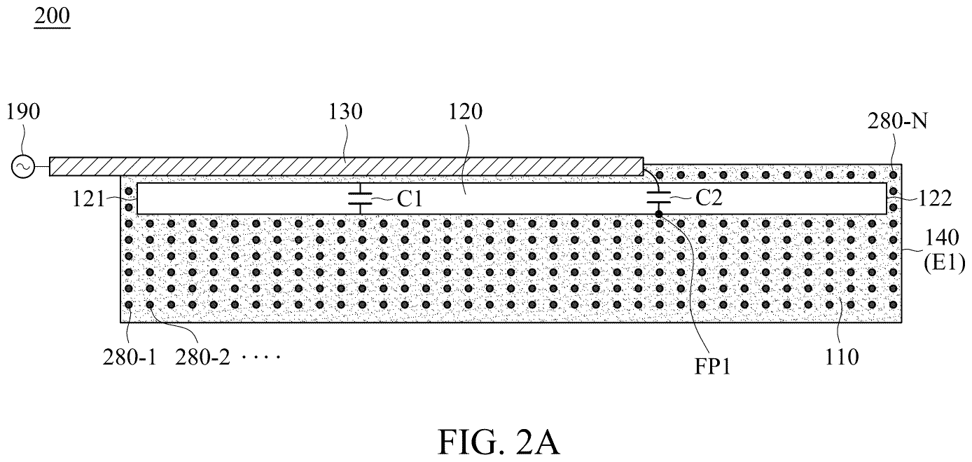

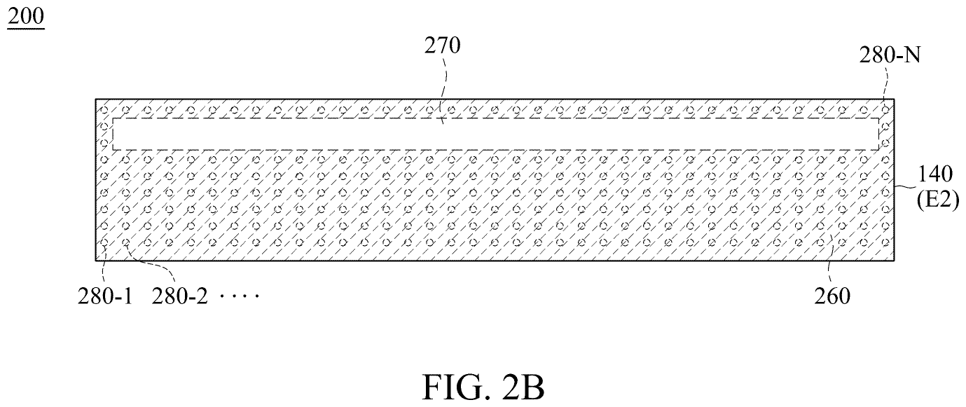

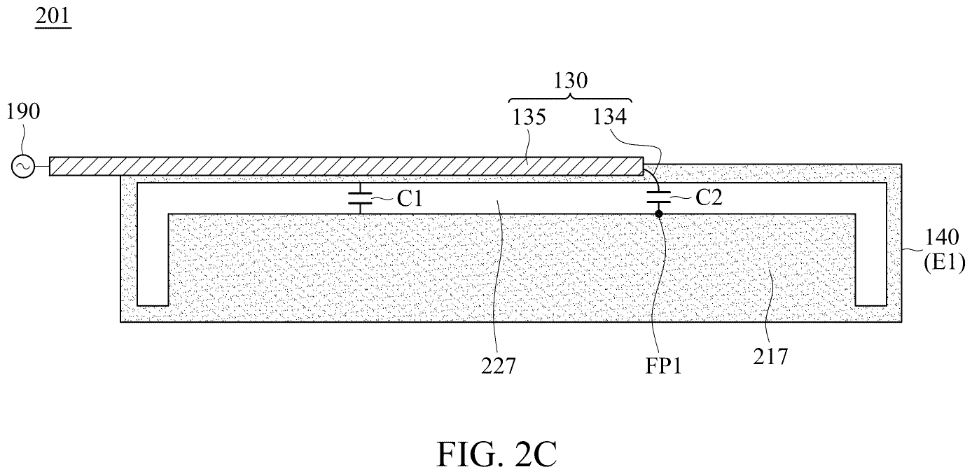

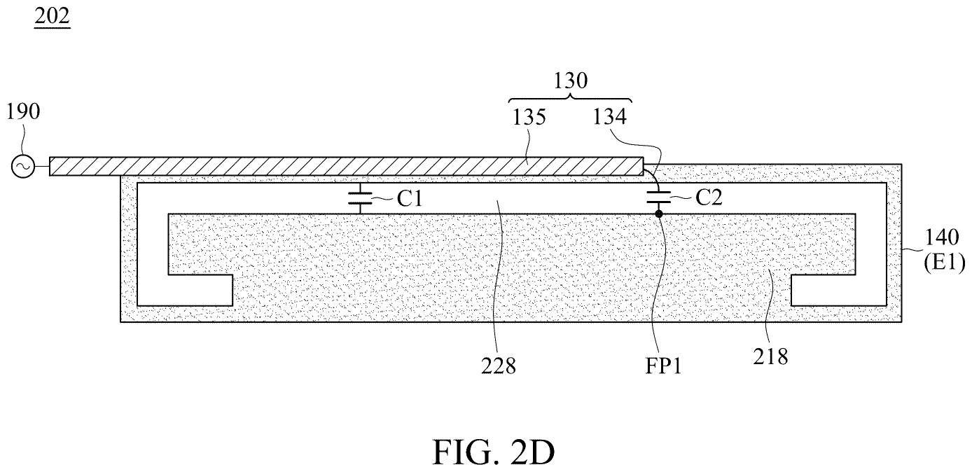

FIG. 2A is a partial view showing the antenna structure 200 according to an embodiment of the present disclosure. FIG. 2B is another partial view showing the antenna structure 200 according to an embodiment of the present disclosure (which can be a perspective view, with some components omitted to simplify the illustration). Please refer to both FIG. 2A and FIG. 2B. FIGS. 2A and 2B are similar to FIGS. 1A and 1B. In the embodiment shown in FIGS. 2A and 2B, the antenna structure 200 further includes a second ground plane 260 and a plurality of conductive via elements 280-1, 280-2, . . . , 280-N, where “N” is any positive integer greater than or equal to 10. For example, the second ground plane 260 and the conductive via elements 280-1, 280-2, . . . , 280-N can all be made of metallic material. The second ground plane 260 is disposed on the second surface E2 of the dielectric substrate 140, wherein the second ground plane 260 has a second slot 270. In some embodiments, the second slot 270 of the second ground plane 260 can be another substantially straight closed slot, which can be substantially aligned with the first slot 120 of the first ground plane 110. The conductive via elements 280-1, 280-2, . . . , 280-N can penetrate the dielectric substrate 140, wherein the conductive via elements 280-1, 280-2, . . . , 280-N can couple the second ground plane 260 to the first ground plane 110. It should be noted that the conductive via elements 280-1, 280-2, . . . , 280-N are distributed over both the narrow edge segment 114 and the wide edge segment 115. According to actual measurement results, the addition of the second ground plane 260 and the conductive via elements 280-1, 280-2, . . . , 280-N helps to further increase the operational bandwidth of the antenna structure 200. The other features of the antenna structure 200 in FIGS. 2A and 2B are similar to those of the antenna structure 100 in FIGS. 1A and 1B, so both embodiments can achieve similar operational effects.

FIG. 2C is a partial view showing the antenna structure 201 according to an embodiment of the present disclosure. FIG. 2C is similar to FIGS. 1A and 1B. In the embodiment shown in FIG. 2C, the first slot 227 of the first ground plane 217 of the antenna structure 201 has a different shape. For example, using the feeding point FP1 as a reference point, the longer portion of the first slot 227 of the first ground plane 217 can be substantially L-shaped, while the shorter portion of the first slot 227 of the first ground plane 217 can be substantially inverted L-shaped. The other features of the antenna structure 201 in FIG. 2C are similar to those of the antenna structure 100 in FIGS. 1A and 1B, so both embodiments can achieve similar operational effects.

FIG. 2D is a partial view showing the antenna structure 202 according to an embodiment of the present disclosure. FIG. 2D is similar to FIGS. 1A and 1B. In the embodiment shown in FIG. 2D, the first slot 228 of the first ground plane 218 of the antenna structure 202 has a different shape. For example, using the feeding point FP1 as a reference point, the longer portion of the first slot 228 of the first ground plane 218 can be substantially J-shaped, while the shorter portion of the first slot 228 of the first ground plane 218 can be substantially inverted J-shaped. The other features of the antenna structure 202 in FIG. 2D are similar to those of the antenna structure 100 in FIGS. 1A and 1B, so both embodiments can achieve similar operational effects.

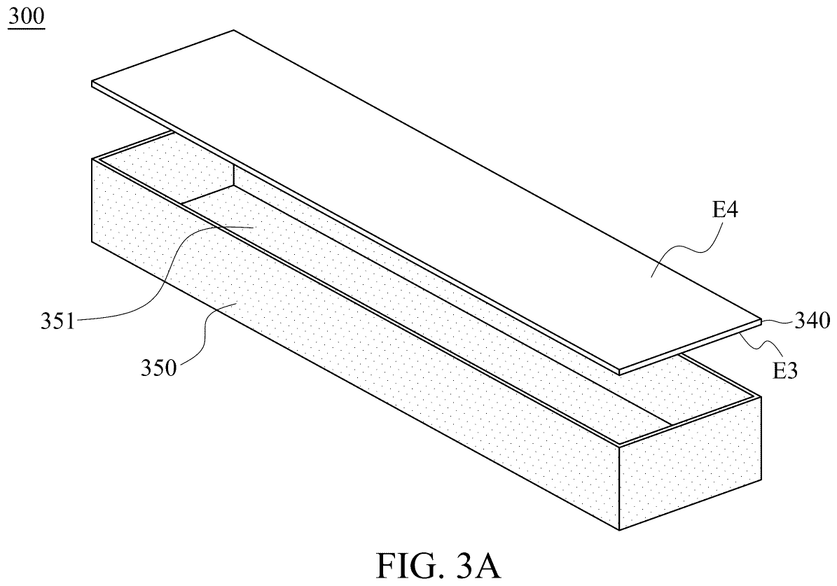

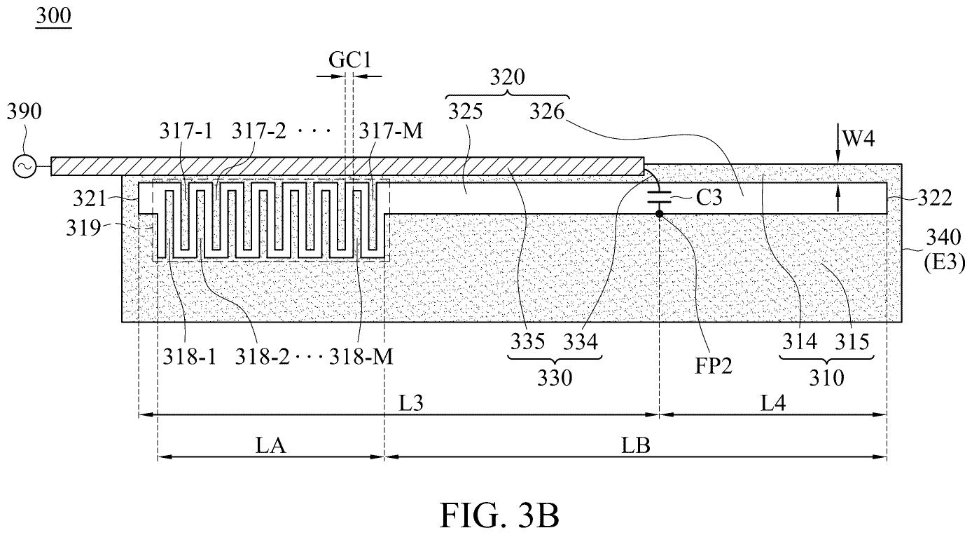

FIG. 3A is an exploded view showing the antenna structure 300 according to an embodiment of the present disclosure. FIG. 3B is a partial view showing the antenna structure 300 according to an embodiment of the present disclosure. In the embodiment shown in FIGS. 3A and 3B, the antenna structure 300 at least includes a first ground plane 310, a cable 330, a dielectric substrate 340, and a metal cavity 350, wherein the first ground plane 310 can be made of metallic material.

The first ground plane 310 includes a narrow edge segment 314 and a wide edge segment 315 that are coupled to each other. Additionally, the first ground plane 310 has a first slot 320, which can be located between the narrow edge segment 314 and the wide edge segment 315. For example, the first slot 320 of the first ground plane 310 can be a substantially closed slot, having a first closed end 321 and a second closed end 322 that are mutually distant. It must be understood that the shape of the first slot 320 of the first ground plane 310 can also be adjusted based on the embodiments shown in FIGS. 2C and 2D.

The narrow edge segment 314 further includes a plurality of first protruding portions 317-1, 317-2, . . . , 317-M, and the wide edge segment 315 further includes a plurality of second protruding portions 318-1, 318-2, . . . , 318-M, where “M” is any positive integer between 2 and 7. The first protruding portions 317-1, 317-2, . . . , 317-M of the narrow edge segment 314 are interleaved with the second protruding portions 318-1, 318-2, . . . , 318-M of the wide edge segment 315 to form a capacitive region 319. In some embodiments, a first coupling gap GC1 can be formed between the first protruding portions 317-1, 317-2, . . . , 317-M of the narrow edge segment 314 and the second protruding portions 318-1, 318-2, . . . , 318-M of the wide edge segment 315.

The cable 330 includes a feeding element 334 and a grounding element 335, wherein the first slot 320 of the first ground plane 310 can be excited by the feeding element 334, and the grounding element 335 is coupled to the narrow edge segment 314. In some embodiments, the feeding element 334 is coupled to a positive electrode of a signal source 390, and the grounding element 335 is coupled to a negative electrode of the signal source 390. In other embodiments, the antenna structure 300 can also include only the feeding element 334, without the cable 330, wherein the feeding element 334 can be implemented by a pogo pin.

In some embodiments, the antenna structure 300 further includes a capacitor C3, wherein the feeding element 334 can be coupled to a feeding point FP2 on the wide edge segment 315 through the capacitor C3. For example, the capacitor C3 can be implemented by a lumped capacitor or a distributed capacitor, but is not limited thereto. Additionally, using the feeding point FP2 as a reference point, the first slot 320 of the first ground plane 310 can be divided into a longer portion 325 and a shorter portion 326, wherein the longer portion 325 of the first slot 320 of the first ground plane 310 can also be integrated with the aforementioned capacitive region 319. It must be understood that the capacitor C3 is merely an optional element and can be removed in other embodiments.

The dielectric substrate 340 has a first surface E3 and a second surface E4 opposite to each other, wherein the first ground plane 310 and the cable 330 can both be disposed on the first surface E3 of the dielectric substrate 340, while no metal components may be arranged on the second surface E4 of the dielectric substrate 340. However, the present disclosure is not limited thereto. In other embodiments, the first ground plane 310 and the cable 330 can also be disposed on the second surface E4 of the dielectric substrate 340.

The metal cavity 350 is coupled to the first ground plane 310. For example, the metal cavity 350 can be a substantially uncovered hollow rectangular cuboid, but is not limited thereto. The metal cavity 350 is adjacent to the dielectric substrate 340. In some embodiments, the first surface E3 of the dielectric substrate 340 faces an open side 351 of the metal cavity 350, allowing the cable 330 to be hidden inside the metal cavity 350.

In some embodiments, the antenna structure 300 can cover a first frequency band and a second frequency band. For example, the first frequency band can be from 2400 MHz to 2500 MHz, and the second frequency band can be from 5150 MHz to 7125 MHz. Furthermore, the operating principle of the antenna structure 300 can be described as follows. The longer portion 325 of the first slot 320 of the first ground plane 310 can be excited to generate the first frequency band. The shorter portion 326 of the first slot 320 of the first ground plane 310 can be excited to generate the second frequency band. According to actual measurement results, the capacitive region 319 can be used to adjust the frequency shift of the first frequency band of the antenna structure 300, while the capacitor C3 can be used to increase the bandwidth of the first frequency band of the antenna structure 300. Additionally, the inclusion of the metal cavity 350 can prevent the radiation performance of the antenna structure 300 from being negatively affected by environmental noise.

In some embodiments, the component sizes and parameters of the antenna structure 300 can be described as follows. The length L3 of the longer portion 325 of the first slot 320 of the first ground plane 310 can be from 0.25 to 0.5 wavelength of the first frequency band of the antenna structure 300 (λ/4˜λ/2). The length L4 of the shorter portion 326 of the first slot 320 of the first ground plane 310 can be from 0.125 to 0.5 wavelength of the second frequency band of the antenna structure 300 (λ/8˜λ/2). The length LA of the capacitive region 319 can be less than the length LB of the remaining part of the first slot 320 of the first ground plane 310. In other embodiments, the length LA of the capacitive region 319 can also be less than or equal to half of the overall length of the first slot 320. The width W4 of the narrow edge segment 314 can be less than or equal to 2 mm. The width of the first coupling gap GC1 can be less than or equal to 1 mm. The capacitance of the capacitor C3 can be less than or equal to 2 pF. The equivalent capacitance of the capacitive region 319 can also be less than or equal to 2 pF. The above component sizes and parameter ranges are derived from multiple experimental results, which help to optimize the operational bandwidth and impedance matching of the antenna structure 300, while also suppressing noise interference in the antenna structure 300.

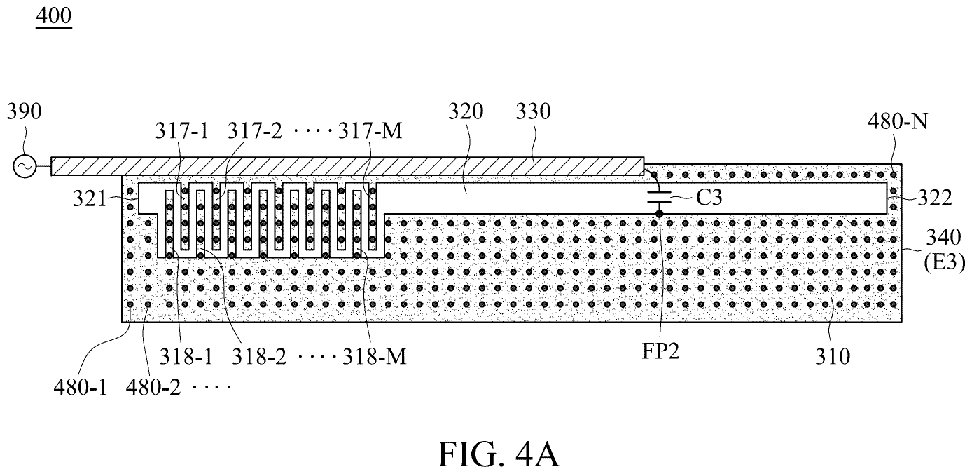

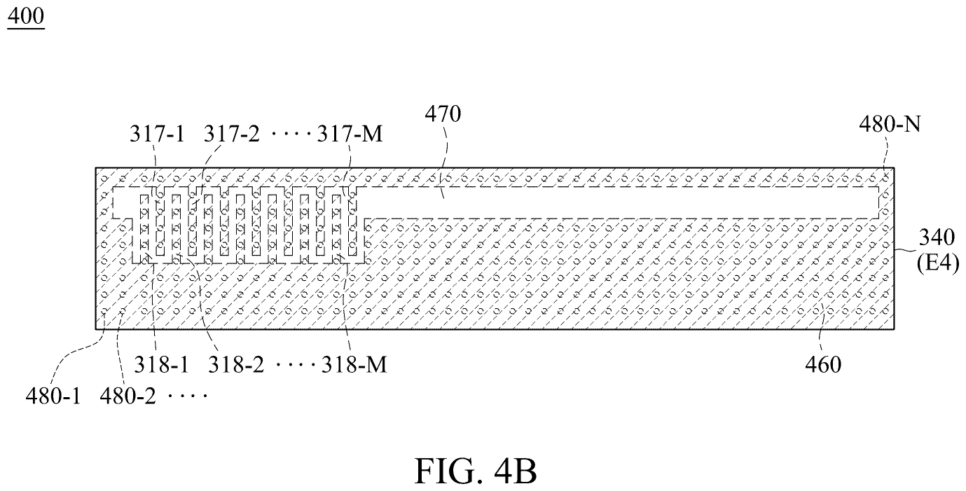

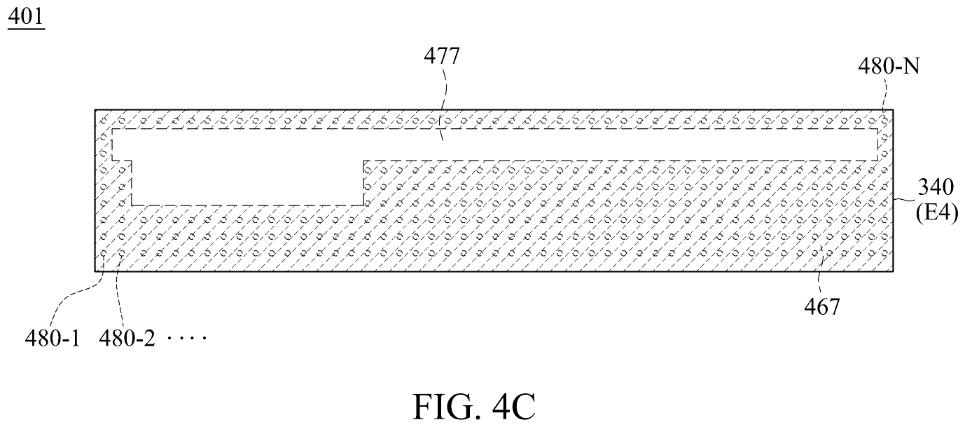

FIG. 4A is a partial view showing the antenna structure 400 according to an embodiment of the present disclosure. FIG. 4B is another partial view showing the antenna structure 400 according to an embodiment of the present disclosure (which can be a perspective view, with some components omitted to simplify the illustration). Please refer to both FIG. 4A and FIG. 4B. FIGS. 4A and 4B are similar to FIGS. 3A and 3B. In the embodiment shown in FIGS. 4A and 4B, the antenna structure 400 further includes a second ground plane 460 and a plurality of conductive via elements 480-1, 480-2, . . . , 480-N. For example, the second ground plane 460 and the conductive via elements 480-1, 480-2, . . . , 480-N can all be made of metallic material. The second ground plane 460 is disposed on the second surface E4 of the dielectric substrate 340, wherein the second ground plane 460 has a second slot 470. In some embodiments, the second slot 470 of the second ground plane 460 can be a substantially closed slot, which can be substantially aligned with the first slot 320 of the first ground plane 310. Additionally, the first ground plane 310 and the second ground plane 460 can almost have the same shape. The conductive via elements 480-1, 480-2, . . . , 480-N can penetrate the dielectric substrate 340, wherein the conductive via elements 480-1, 480-2, . . . , 480-N can couple the second ground plane 460 to the first ground plane 310. It should be noted that the conductive via elements 480-1, 480-2, . . . , 480-N are distributed over the narrow edge segment 314 and its first protruding portions 317-1, 317-2, . . . , 317-M, as well as the wide edge segment 315 and its second protruding portions 318-1, 318-2, . . . , 318-M. According to actual measurement results, the addition of the second ground plane 460 and the conductive via elements 480-1, 480-2, . . . , 480-N helps to further increase the operational bandwidth of the antenna structure 400. The other features of the antenna structure 400 in FIGS. 4A and 4B are similar to those of the antenna structure 300 in FIGS. 3A and 3B, so both embodiments can achieve similar operational effects.

FIG. 4C is a partial view showing the antenna structure 401 according to an embodiment of the present disclosure (which can be a perspective view, with some components omitted to simplify the illustration). FIG. 4C is similar to FIGS. 3A and 3B. In the embodiment shown in FIG. 4C, the second slot 477 of the second ground plane 467 of the antenna structure 401 has a different shape. For example, the second slot 477 of the second ground plane 467 can be a substantially unequal-width strip, but it does not have any capacitive region. The other features of the antenna structure 401 in FIG. 4C are similar to those of the antenna structure 300 in FIGS. 3A and 3B, so both embodiments can achieve similar operational effects.

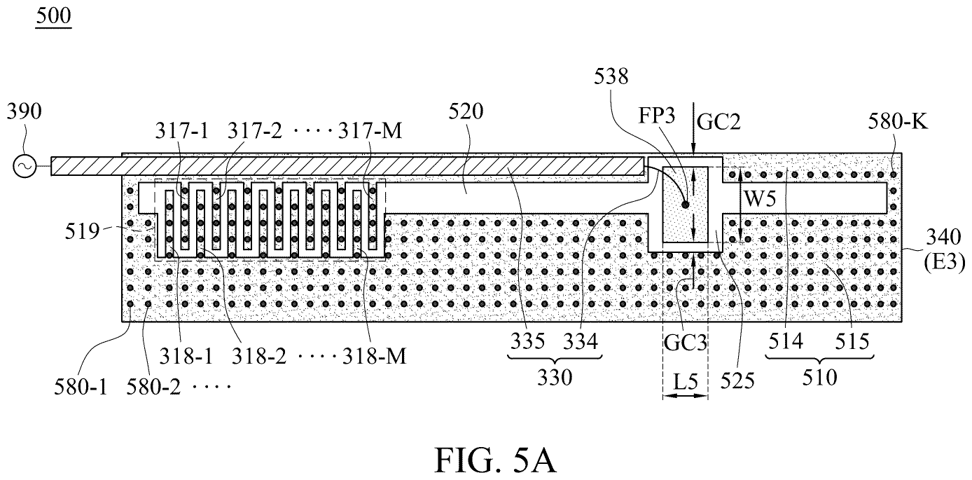

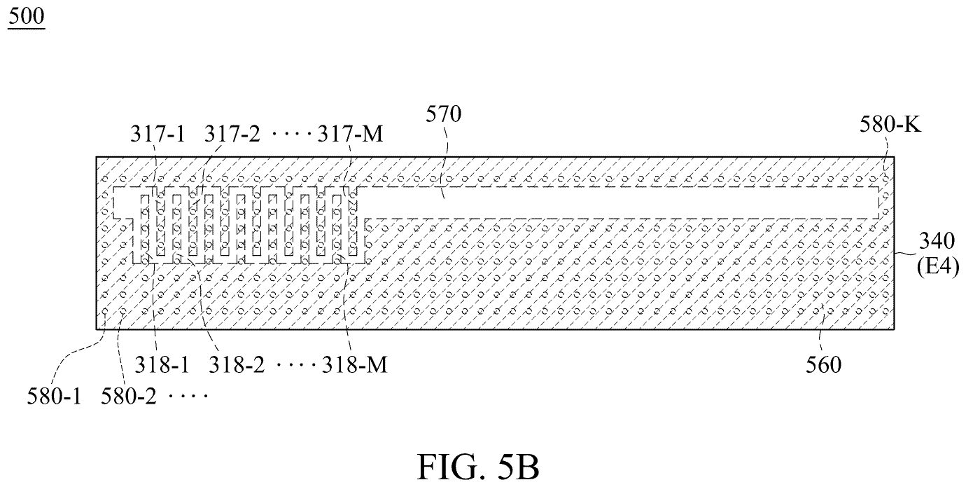

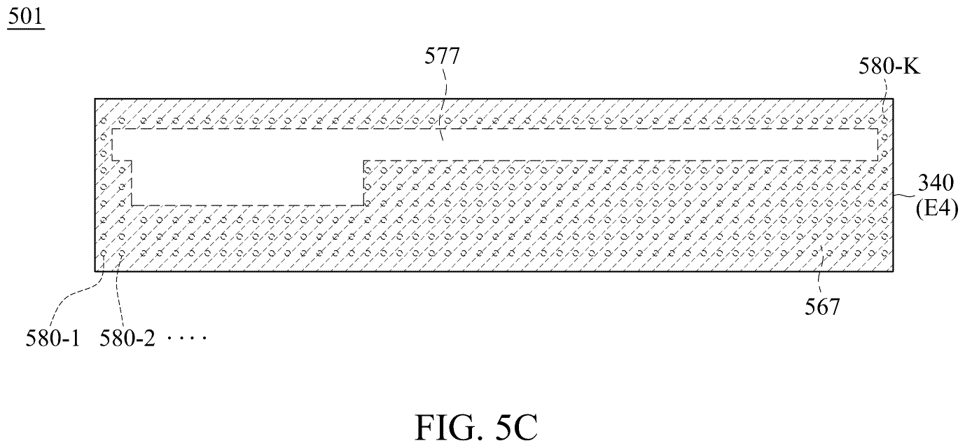

FIG. 5A is a partial view showing the antenna structure 500 according to an embodiment of the present disclosure. FIG. 5B is another partial view showing the antenna structure 500 according to an embodiment of the present disclosure (which can be a perspective view, with some components omitted to simplify the illustration). Please refer to both FIG. 5A and FIG. 5B. FIGS. 5A and 5B are similar to FIGS. 3A and 3B. In the embodiment shown in FIGS. 5A and 5B, the antenna structure 500 further includes an independent metal element 538, a second ground plane 560, and a plurality of conductive via elements 580-1, 580-2, . . . , 580-K, where “K” is any positive integer greater than or equal to 10. The independent metal element 538 is disposed inside the first slot 520 of the first ground plane 510 of the antenna structure 500. For example, the independent metal element 538 can be substantially rectangular or square, but is not limited thereto. Additionally, the first slot 520 of the first ground plane 510 can include a widening portion 525 to accommodate the independent metal element 538. It must be understood that the shape of the first slot 520 of the first ground plane 510 can also be adjusted based on the embodiments shown in FIGS. 2C and 2D. The feeding element 334 is coupled to a feeding point FP3 on the independent metal element 538. The independent metal element 538 is adjacent to the narrow edge segment 514 and the wide edge segment 515 of the first ground plane 510 to provide a feeding capacitance. In some embodiments, a second coupling gap GC2 can be formed between the independent metal element 538 and the narrow edge segment 514, and a third coupling gap GC3 can be formed between the independent metal element 538 and the wide edge segment 515. For example, the length L5 of the independent metal element 538 can be from 2 mm to 10 mm, the width W5 of the independent metal element 538 can also be from 2 mm to 10 mm, and the width of each of the second coupling gap GC2 and the third coupling gap GC3 can be less than or equal to 2 mm. The second ground plane 560 is disposed on the second surface E4 of the dielectric substrate 340, wherein the second ground plane 560 has a second slot 570. In some embodiments, the second slot 570 of the second ground plane 560 can be a substantially closed slot, which can be substantially aligned with the first slot 520 of the first ground plane 510. The first ground plane 510 and the second ground plane 560 can almost have the same shape. The conductive via elements 580-1, 580-2, . . . , 580-K can penetrate the dielectric substrate 340, wherein the conductive via elements 580-1, 580-2, . . . , 580-K can couple the second ground plane 560 to the first ground plane 510. It should be noted that the conductive via elements 580-1, 580-2, . . . , 580-N are not distributed over the independent metal element 538. In some embodiments, the independent metal element 538 has a vertical projection on the second surface E4 of the dielectric substrate 340, and this vertical projection at least partially overlaps with the second slot 570 of the second ground plane 560. In other embodiments, the capacitive region 519 of the antenna structure 500 can also be replaced by another capacitor. The other features of the antenna structure 500 in FIGS. 5A and 5B are similar to those of the antenna structure 300 in FIGS. 3A and 3B, so both embodiments can achieve similar operational effects.

It must be understood that the independent metal element 538 can also be applied to the antenna structure 100 shown in FIGS. 1A and 1B, wherein the second capacitor C2 can be replaced by the independent metal element 538, and the shape of the first slot 120 of the first ground plane 110 can also be appropriately adjusted to accommodate the independent metal element 538. Similarly, the independent metal element 538 can also be applied to the antenna structure 300 shown in FIGS. 3A and 3B, wherein the capacitor C3 can also be replaced by the independent metal element 538, and the shape of the first slot 320 of the first ground plane 310 can also be appropriately adjusted to accommodate the independent metal element 538.

FIG. 5C is a partial view showing the antenna structure 501 according to an embodiment of the present disclosure (which can be a perspective view, with some components omitted to simplify the illustration). FIG. 5C is similar to FIGS. 5A and 5B. In the embodiment shown in FIG. 5C, the second slot 577 of the second ground plane 567 of the antenna structure 501 has a different shape. For example, the second slot 577 of the second ground plane 567 can be a substantially unequal-width strip, but it does not have any capacitive region. The other features of the antenna structure 501 in FIG. 5C are similar to those of the antenna structure 500 in FIGS. 5A and 5B, so both embodiments can achieve similar operational effects.

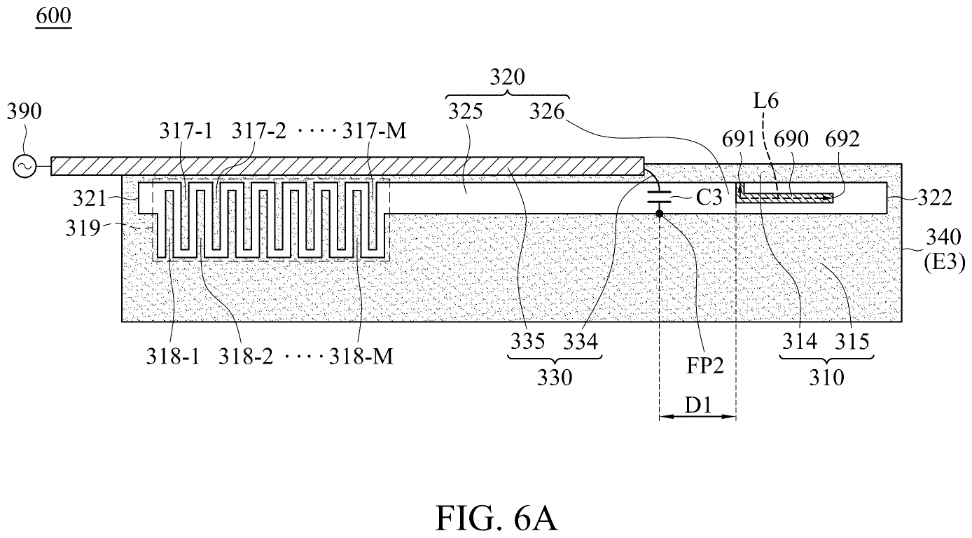

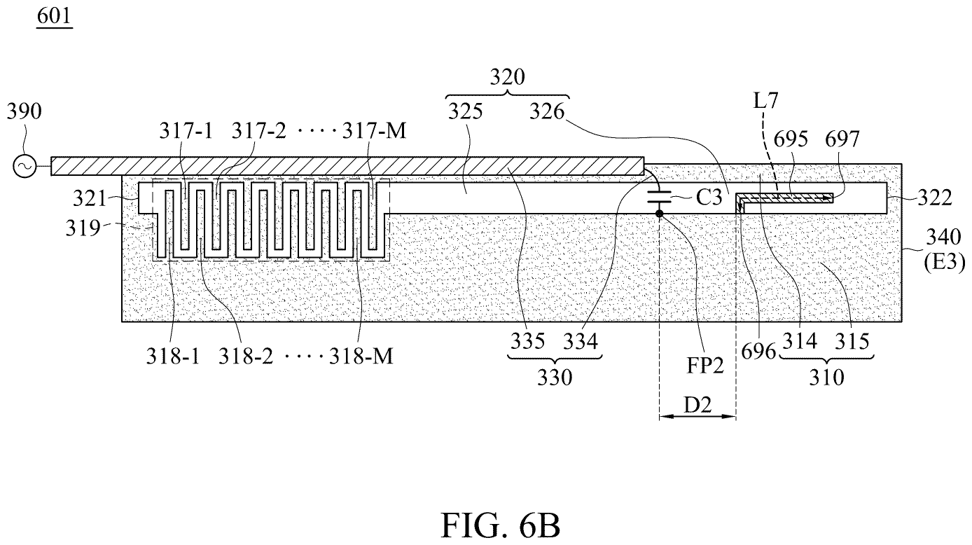

FIG. 6A is a partial view showing the antenna structure 600 according to an embodiment of the present disclosure. FIG. 6A is similar to FIGS. 3A and 3B. In the embodiment shown in FIG. 6A, the antenna structure 600 further includes an additional metal element 690, which can be disposed inside the shorter portion 326 of the first slot 320 of the first ground plane 310. For example, the additional metal element 690 can be substantially L-shaped. Specifically, the additional metal element 690 has a first end 691 and a second end 692, wherein the first end 691 of the additional metal element 690 is coupled to the narrow edge segment 314, and the second end 692 of the additional metal element 690 is an open end extending towards the direction near the second closed end 322 of the first slot 320 of the first ground plane 310. According to actual measurement results, the additional metal element 690 can be used to fine-tune the impedance matching of the second frequency band of the antenna structure 600. In some embodiments, the length L6 of the additional metal element 690 can be less than or equal to 8 mm, and the distance D1 between the additional metal element 690 and the feeding point FP2 can be less than or equal to 6 mm. The other features of the antenna structure 600 in FIGS. 6A and 6B are similar to those of the antenna structure 300 in FIGS. 3A and 3B, so both embodiments can achieve similar operational effects.

FIG. 6B is a partial view showing the antenna structure 601 according to an embodiment of the present disclosure. FIG. 6B is similar to FIGS. 3A and 3B. In the embodiment shown in FIG. 6B, the additional metal element 695 of the antenna structure 601 has a first end 696 and a second end 697, wherein the first end 696 of the additional metal element 695 is coupled to the wide edge segment 315, and the second end 697 of the additional metal element 695 is an open end. According to actual measurement results, the additional metal element 695 can also be used to fine-tune the impedance matching of the second frequency band of the antenna structure 601. In some embodiments, the length L7 of the additional metal element 695 can be less than or equal to 8 mm, and the distance D2 between the additional metal element 695 and the feeding point FP2 can be less than or equal to 6 mm. The other features of the antenna structure 600 in FIGS. 6A and 6B are similar to those of the antenna structure 300 in FIGS. 3A and 3B, so both embodiments can achieve similar operational effects.

It must be understood that the additional metal element 690 in FIG. 6A or the additional metal element 695 in FIG. 6B can also be added to any of the previously described embodiments of the antenna structure, thereby allowing fine-tuning of impedance matching and improvement of radiation efficiency.

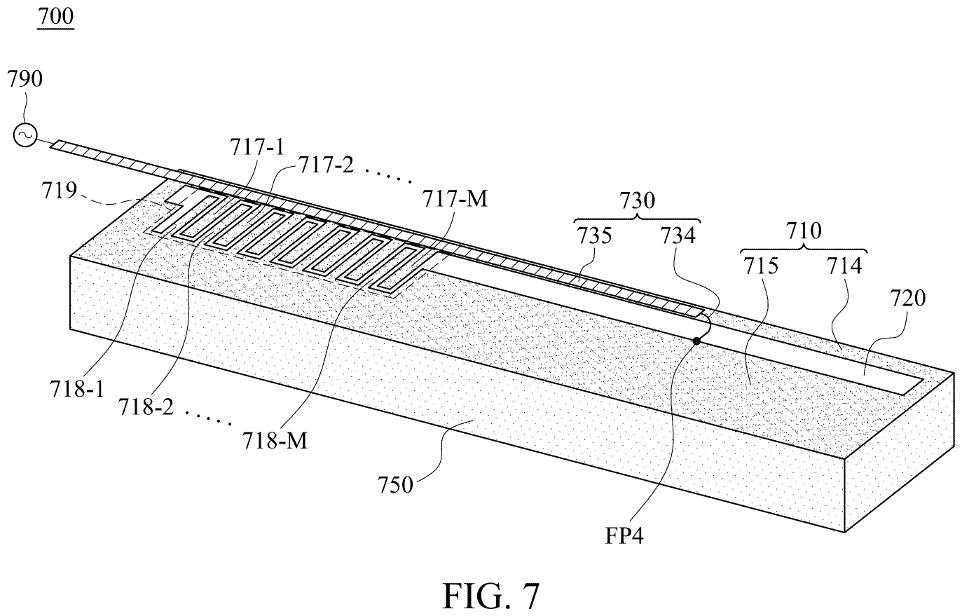

FIG. 7 is a perspective view showing the antenna structure 700 according to an embodiment of the present disclosure. FIG. 7 is similar to FIGS. 3A and 3B. In the embodiment shown in FIG. 7, the antenna structure 700 includes a cable 730 and a metal cavity 750. The metal cavity 750 includes a metal mechanism element 710, which can be considered as an upper cover of the metal cavity 750. The metal mechanism element 710 includes a narrow edge segment 714 and a wide edge segment 715 that are coupled to each other, wherein the metal mechanism element 710 has a slot 720 located between the narrow edge segment 714 and the wide edge segment 715. Since the metal cavity 750 is of an integrally formed design, the antenna structure 700 does not require any dielectric substrate, thereby simplifying its manufacturing process.

Similarly, the narrow edge segment 714 further includes a plurality of first protruding portions 717-1, 717-2, . . . , 717-M, and the wide edge segment 715 further includes a plurality of second protruding portions 718-1, 718-2, . . . , 718-M. The first protruding portions 717-1, 717-2, . . . , 717-M of the narrow edge segment 714 are interleaved with the second protruding portions 718-1, 718-2, . . . , 718-M of the wide edge segment 715 to form a capacitive region 719. The cable 730 includes a feeding element 734 and a grounding element 735, wherein the feeding element 734 is coupled to a feeding point FP4 on the wide edge segment 715, and the grounding element 735 is coupled to the narrow edge segment 714. In some embodiments, the feeding element 734 is coupled to a positive electrode of a signal source 790, and the grounding element 735 is coupled to a negative electrode of the signal source 790. In some embodiments, the antenna structure 700 can cover a first frequency band and a second frequency band. For example, the first frequency band can be from 2400 MHz to 2500 MHz, and the second frequency band can be from 5150 MHz to 7125 MHz. The other features of the antenna structure 700 in FIG. 7 are similar to those of the antenna structure 300 in FIGS. 3A and 3B, so both embodiments can achieve similar operational effects.

The present disclosure proposes a novel antenna structure. Compared to traditional designs, the present disclosure has advantages such as small size, wide bandwidth, suppression of environmental noise, and improved communication quality, making it very suitable for application in various communication devices.

Although the present disclosure has been disclosed above with specific preferred embodiments, it is not intended to limit the present disclosure. A person skilled in the art can still make some modifications and refinements without departing from the spirit and scope of the present disclosure. Therefore, the protection scope of the present disclosure should be defined by the claims below.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna structure, comprising:
a first ground plane, comprising a narrow edge segment and a wide edge segment, wherein the first ground plane has a first slot;
a first capacitor, coupled between the narrow edge segment and the wide edge segment;
a feeding element, wherein the first slot of the first ground plane is excited by the feeding element;
a dielectric substrate, having a first surface and a second surface opposite to each other, wherein the first ground plane, the first capacitor, and the feeding element are disposed on the first surface of the dielectric substrate; and
a metal cavity, coupled to the first ground plane, wherein the metal cavity is adjacent to the dielectric substrate.

2. The antenna structure of claim 1, further comprising:
a second capacitor, wherein the feeding element is coupled to a feeding point on the wide edge segment through the second capacitor.

3. The antenna structure of claim 2, wherein a capacitance of each of the first capacitor and the second capacitor is less than or equal to 2 pF.

4. The antenna structure of claim 2, wherein the antenna structure covers a first frequency band and a second frequency band, wherein the first frequency band is lower than the second frequency band.

5. The antenna structure of claim 4, wherein using the feeding point as a reference point, the first slot of the first ground plane is divided into a longer portion and a shorter portion, a length of the longer portion is from 0.25 to 0.5 wavelength of the first frequency band, and a length of the shorter portion is from 0.125 to 0.5 wavelength of the second frequency band.

6. The antenna structure of claim 1, further comprising:
an independent metal element, disposed inside the first slot of the first ground plane, wherein the feeding element is coupled to a feeding point on the independent metal element, and the independent metal element is adjacent to the narrow edge segment and the wide edge segment.

7. An antenna structure, comprising:
a first ground plane, comprising a narrow edge segment and a wide edge segment, wherein the first ground plane has a first slot;
a feeding element, wherein the first slot of the first ground plane is excited by the feeding element; and
a dielectric substrate, having a first surface and a second surface opposite to each other, wherein the first ground plane and the feeding element are both disposed on the first surface of the dielectric substrate; and
a metal cavity, coupled to the first ground plane, wherein the metal cavity is adjacent to the dielectric substrate;
wherein the narrow edge segment further comprises a plurality of first protruding portions, and the wide edge segment further comprises a plurality of second protruding portions, the first protruding portions and the second protruding portions are arranged in an interleaved manner to form a capacitive region.

8. The antenna structure of claim 7, wherein the metal cavity is an uncovered hollow rectangular cuboid.

9. The antenna structure of claim 8, wherein the first surface of the dielectric substrate faces an open side of the metal cavity.

10. The antenna structure of claim 7, wherein a first coupling gap is formed between the first protruding portions of the narrow edge segment and the second protruding portions of the wide edge segment, and a width of the first coupling gap is less than or equal to 1mm.

11. The antenna structure of claim 7, wherein a length of the capacitive region is less than that of the other portions of the first slot of the first ground plane.

12. The antenna structure of claim 7, further comprising:
a capacitor, wherein the feeding element is coupled to a feeding point on the wide edge segment through the capacitor.

13. The antenna structure of claim 12, wherein a capacitance of the capacitor is less than or equal to 2 pF.

14. The antenna structure of claim 7, further comprising:
a second ground plane, disposed on the second surface of the dielectric substrate, wherein the second ground plane has a second slot; and
a plurality of conductive via elements, penetrating the dielectric substrate,
wherein the conductive via elements couple the second ground plane to the first ground plane.

15. The antenna structure of claim 14, wherein the second slot of the second ground plane is substantially aligned with the first slot of the first ground plane.

16. The antenna structure of claim 14, further comprising:
an independent metal element, disposed inside the first slot of the first ground plane, wherein the feeding element is coupled to a feeding point on the independent metal element, and the independent metal element is adjacent to the narrow edge segment and the wide edge segment.

17. The antenna structure of claim 16, wherein a second coupling gap is formed between the independent metal element and the narrow edge segment, and a third coupling gap is formed between the independent metal element and the wide edge segment, and a width of each of the second coupling gap and the third coupling gap is less than or equal to 2mm.

18. The antenna structure of claim 16, wherein the independent metal element has a vertical projection on the second surface of the dielectric substrate, and the vertical projection at least partially overlaps the second slot of the second ground plane.

19. The antenna structure of claim 7, further comprising:
an additional metal element, disposed inside the first slot of the first ground plane, wherein the additional metal element is coupled to the narrow edge segment or the wide edge segment.

20. An antenna structure, comprising:
a metal cavity, comprising a metal mechanism element with a slot, wherein the metal mechanism element comprises a narrow edge segment and a wide edge segment; and
a cable, comprising a feeding element and a grounding element, wherein the feeding element is coupled to the wide edge segment, and the grounding element is coupled to the narrow edge segment;
wherein the narrow edge segment further comprises a plurality of first protruding portions, and the wide edge segment further includes a plurality of second protruding portions, the first protruding portions and the second protruding portions are arranged in an interleaved manner to form a capacitive region.
